(19) United States
(12) Patent Application Publication
(10) Pub. No.: US 2015/0019469 A1
(43) Pub. Date: Jan. 15, 2015

(54) METHOD OF RECOMMENDING ITEMS TO A GROUP OF USERS

(71) Applicant: THOMSON LICENSING, Issy de Moulineaux (FR)

(72) Inventors: Stratis Ioannidis, San Francisco, CA (US); Jinyun Yan, Sunnyvale, CA (US); Jose Bento Ayres Pereira, Cambridge, MA (US)

(73) Assignee: Thomson Licensing, Issy de Moulineaux (FR)

(21) Appl. No.: 14/382,565

(22) PCT Filed: Dec. 13, 2012
(86) PCT No.: PCT/US12/69370

§ 371 Date: Sep. 3, 2014

Related U.S. Application Data
(60) Provisional application No. 61/608,171, filed on Mar. 8, 2012.

(51) Int. Cl. G06N 7/00

(52) U.S. Cl. CPC G06N 7/00
USPC 706/46

(57) ABSTRACT

A method for generating a recommendation item for members of a group includes registering a plurality of users as members of the group, identifying a subgroup of members of the group of users wherein the subgroup requests a recommendation item from a recommendation engine, calculating, using a multi-armed bandit algorithm, a recommendation item for the subgroup of members. The recommendation item is provided to the subgroup members for their evaluation. After evaluating the recommendation item, the individual users rate the recommendation item which updates the recommendation engine with preferences representing the members of the subgroup.

### CROSS REFERENCE TO RELATED APPLICATION

This application claims priority to U.S. Provisional Application No. 61/608,171 entitled “Method for Recommending Items to a Group of Users”, filed on 8 Mar. 2012, which is hereby incorporated by reference in its entirety for all purposes.

### FIELD

The present invention relates to computer-generated recommendations to group of users. Specifically, the invention relates to the generation of computer-generated recommendations to a known group of uses though the use of interface devices such as mobile and other computing devices having user interfaces.

### BACKGROUND

Consider a group of people that get together regularly to perform a social activity, such as watching a movie or dining at a restaurant. These people can be, e.g., a family sitting in front of their TV to watch a movie, a group of friends going to a theatre, or a group of colleagues wishing to decide at which restaurant to have lunch. The social activity takes place multiple times, and the persons participating in the activity might change from one session to the next. At each session, the participants can engage in the activity by selecting one of many possible options. For example, when watching a movie, the participants can choose a movie among many different genres, such as horror, action, romantic, etc. In the case of restaurant selection, the participants can chose one of multiple cuisines, such as Italian, Chinese, etc.

One problem in generating a recommendation for a group is how to select an option that matches best the interests of the group of participants present in the system given that (a) their interest in an option (genre or cuisine) is not a-priori known, but is only revealed from feedback they give after they participate in the social activity (e.g. view and rate a horror movie or dine at an Italian restaurant) and (b) the group can change from one session to the next.

Prior work on recommendation to groups has been inspired by many different applications. For example, J. Masthoff who authored “Group modeling: Selecting a sequence of television items to suit a group of viewers, 2004” recommends a sequence of digital TV programs to groups. Tourism suggestion is also a popular topic. G. P. Liliana Ardissono, Anna Goy, M. Segnan, and P. Torasso in Intrigue: “Personalized recommendation of tourist attractions for desktop and handset devices” in Applied Artificial Intelligence, pages 687-714, 2003, and L. C. Kevin McCarthy, Maria Salam, L. McGinty, B. Smyth, and P. Nixon in Cats: “A synchronous approach to collaborative group recommendation” in The Nineteenth International Florida Artificial Intelligence Research Society Conference, 2006, help friends or tourist groups plan a vacation or sightseeing tour. Group Modeler W. N. J. Kay, in “Adapting information delivery to groups of people” in the First International Workshop on New Technologies for Personalized Information Access at the 10th International Conference on User Modeling, 2005, is designed for people visiting a museum as a group. J. F. McCarthy in pocket restaurant finder: “A situated recommender system for groups” in “The Workshop on Mobile Ad-Hoc Communication at CHI, 2002, aims at colleagues going out to dine together. Another application is to recommend music. A. T. Joseph F. McCarthy in Musicfx:” An arbiter of group preferences for computer supported collaborative workouts” in Computer-Supported Cooperative Work, 1998, recommends music stations to persons working out in a gym.

Past research on group recommendation has mainly focused on identifying an “objective” function to optimize while satisfying groups, rather than individuals. In some cases, the objective function is formally defined and defended. Inspired by Social Choice Theory, J. Masthoff discussed and examined strategies like “the Average Strategy”, “the Average without Misery Strategy”, and “the Least Misery Strategy”. In other cases, authors propose specific algorithms to make group recommendations, which implicitly optimize some sophisticated objective function over the group. G. J.-D. Juan A Recio-Garcia, A. A. Sanchez-Ruiz, and B. Diaz-Agudo in “Personality aware recommendations to groups” in Proceedings of the third ACM conference on Recommender systems RecSys, 2009, uses collaborative filtering techniques to make recommendation and takes personality composition into consideration. A. C. Sihem AmerYahia, Senjuti Basu Roy, G. Das, and C. Yu in “Group recommendation: Semantics and efficiency” in VLDB, 2009, proposes the semantic of group recommendation, taking account of item relevance to the group and disagreements among group members. Items having large relevance score and small disagreement score are candidates to recommend. They use the top-k algorithm to pick k candidates efficiently. F. R. Linas Baltrunas, Tadas Makcinskas in “Group recommendations with rank aggregation and collaborative filtering” in Recsys, 2010, combines collaborative filtering and rank aggregation. They create a ranked recommendation list to each user in the group first, then aggregate the lists and generate a ranked list with common items to the group. J. F. Shlomo Berkovsky in “Group-based recipe recommendations: analysis of data aggregation strategies”, in Recsys, 2010, also takes advantage of collaborative filtering techniques, but aggregates user profiles to a group profile, then applies collaborative filtering on the aggregated profile. The recommendation to one group is made based on preferences of other similar groups. To the best of knowledge of the inventors, no prior work addresses the issues of group recommendation that is addressed by the present invention, such as the dynamics of the members of a group over time, or learning over time.

### SUMMARY

This summary is provided to introduce a selection of concepts in a simplified form that are further described below in the Detailed Description. The Summary is not intended to identify key features or essential features of the claimed subject matter, not is it intended to be used to limit the scope of the claimed subject matter.

The present invention determines a method for recommending items such as movies or restaurants to a group of users. The method is able to deal with a dynamic group of people performing a joint social activity, such as a family watching a movie or a group of coworkers dinning out for lunch, whose members may irregularly show up and participate in the social activity. The method learns how users react to recommendations from feedback that they provide, and provides recommendations that meet the dual goal of satisfying the participants that turn up at the social activity while also exploring their interests, thereby improving the quality of recommendations every time.

The multi-arm bandit mathematical approach is used in the invention to address the above-referenced issues with respect to providing group recommendations. The mathematical theory of multi-arm bandits is extensive, with myriad versions studied from many arms, to delays, dependence among the arms, and so on. Still, the present inventive variation, with users appearing in multiple, different groups over time, is new, as is the inventive algorithm. In related work, there are so-called linear or contextual bandits, which have been applied to personalized recommendations at the individual user recommendation level and not the group level recommendation level. In contextual bandits, the reward of an arm can be expressed as an inner product of an observable context vector and a set of latent variables. The present inventive approach departs from prior art contextual bandits by having access not only to the final group rating, as in the prior art, but also to individual rating of users, which are latent and not observed in the standard prior art contextual bandit model. The prior art has devised algorithms in setups where only the sum of the ratings is known, but not the individual ratings. In one aspect of the present invention, individual ratings heretofore suppressed in prior art methods are used to advantage. This in turn, allows the present invention to obtain a better bound in terms of a measure called regret (which is typically not logarithmic for contextual bandits).

In one aspect of the invention, a method for generating a recommendation item for members of a group includes registering a plurality of users as members of the group, identifying a subgroup of members of the group of users wherein the subgroup requests a recommendation item from a recommendation engine, calculating, using a multi-armed bandit algorithm, a recommendation item for the subgroup of members. The recommendation item is provided to the subgroup members for their evaluation. After evaluating the recommendation item, the individual users rate the recommendation item which updates the recommendation engine with preferences representing the members of the subgroup.

Additional features and advantages of the invention will be made apparent from the following detailed description of illustrative embodiments which proceeds with reference to the accompanying figures.

### BRIEF DESCRIPTION OF THE DRAWINGS

The foregoing summary of the invention, as well as the following detailed description of illustrative embodiments, is better understood when read in conjunction with the accompanying drawings, which are included by way of example, and not by way of limitation with regard to the claimed invention.

FIG. 1 illustrates an embodiment having multiple user devices interconnected to a recommendation engine according to aspects of the invention;

FIG. 2 illustrates an embodiment of a smart TV having a recommendation engine according to aspects of the invention;

FIG. 3 illustrates an embodiment using cloud-based resources to house the recommendation engine according to aspects of the invention;

FIG. 4 illustrates an example flow diagram of a use according to aspects of the invention;

FIG. 5 illustrates an example user device according to aspects of the invention;

FIG. 6 illustrates an example recommendation engine according to aspects of the invention.

### DETAILED DISCUSSION OF THE EMBODIMENTS

In the following description of various illustrative embodiments, reference is made to the accompanying drawings, which form a part thereof, and in which is shown, by way of illustration, various embodiments in the invention may be practiced. It is to be understood that other embodiments may be utilized and structural and functional modification may be made without departing from the scope of the present invention.

In one aspect of the invention, a group recommendation is formulated as a multi-armed bandit problem. In the classic and well-known multi-armed bandit algorithm, the functions of a gambler and arms can be identified. In the present invention, the gambler is replaced by a recommender or a recommendation engine and the arms are replaced by categories of objects. In particular, in the present invention, consider a group G of d=|G| users that get together regularly to perform a social activity, such as watching a movie or dining at a restaurant. The users participating in the activity might change from one session to the next; denoted by S(t)⊂G, t=0, 1, 2, . . . , the set of users that are present at the t-th session. A recommender, implemented as a recommendation engine, is designed such that, at each session, a suggestion of a new object (e.g., a movie or a restaurant) around which the social activity will revolve is made. Objects suggested may belong to one of K different categories. For example, movie categories may correspond to genres (such as comedy, action, horror, etc.) while restaurant categories may correspond to cuisines (such as Chinese, Italian, etc.). For this embodiment, keeping in mind that the model can be generalized to many group situations, objects may be suggested by the recommendation engine as movies and to categories as genres.

In particular, at each session, the recommendation engine selects a genre using a modified multi-armed bandit (MMAB) algorithm. It then proceeds by suggesting a movie from that genre to the users present in the session. A is denoted with |A|=K, the set of all possible genres. Ideally, the recommendation engine should select a genre that best matches the preferences of the users present in the current session. Whenever u E G is suggested a movie, her satisfaction is measured by a real-valued rating. This could be for example a rating between one and five stars, or a fraction rating between 0 (lowest rating) and 1 (highest rating).

At each session t, after being suggested a movie, the users in S(t) report their satisfaction by disclosing their ratings to the recommendation engine. Users need not view the movie suggested; for example, they may provide a rating immediately for a movie already watched in the past, and proceed to solicit another recommendation (i.e., hold another session). Group satisfaction is measured through an aggregate group rating, which is a linear function of the ratings of the individuals present. In particular, if the rating provided by a user u∈S(t) is rᵤ(t), the group rating is given by Σ_{u∈s(t)×u(t)*ru(t)}, where xᵤ(t) is the weight of user u∈S(t). The weight of a user is a design parameter selected by the recommender, and it is used by the latter to capture the importance it assigns to the opinions of user u. The Choosing different weights allow capture of different types of aggregate “group ratings”. For example, setting xᵤ(t)=1 makes the aggregate group rating equal to the sum of ratings of users present in the system, while setting xᵤ(t)=wᵤ, for some wᵤ, gives different weights to different users.

Let a(t)∈A be the genre selected by the recommendation engine at the t-th session. The recommendation engine selects Genre a(t) based on the following information:
1. The weight vector x(t) at time t, and
2. The past weight vectors x(τ), genres a(τ) and ratings rᵤ(τ) received by users u∈S(τ), for τ<t.

Note that the recommendation engine knows the weight vector at time t. For example, in the case of weights given by wᵤ, this means that the recommendation engine has access to the relative weights wᵤ as well as the composition of the group or subgroup of users of present users S(t) at time t. On the other hand, the ratings of users at time t are revealed only after the movie suggestion, and thus can only be used in future genre selections. A more detailed description of the policy proposed is provided below.

The MMAB recommendation engine maintains estimates of the following quantities θᵤₐ, for all users u∈G and all genres a∈A: if u has rated movies from genre a for s times so far, the quantity θ_{u,a} is the empirical average

$${\overline{θ}}_{u , a} ( s ) = \frac{1}{s} {\sum }_{τ = 1}^{s} {r}_{u} ( τ ) ,$$

where rᵤ is the rating user u gave to τ-th movie from genre a. Moreover, the recommendation engine keeps track of how many times a user has participated in the activity and a particular genre has been displayed. More formally, let [symbol] (E) be the characteristic function of an event E (1 if E is true and zero otherwise). The recommendation engine keeps track of

$${n}_{u , a} ( T ) - {\sum }_{t = 1}^{T} ( u ∈ S ( t ) and a ( t ) - a )$$

i.e., the number of times that u has been present and a movie from genre a has been suggested upto session T, as well as

$${n}_{u} ( T ) = {\sum }_{t = 1}^{T} ( u ∈ S ( t ) )$$

the number of times that u has been present upto session T. Using the above quantities, the recommendation engine selects a genre as follows. At the t-th session, the recommendation engine first observes the present composition of group S(t) and the present weight vector x(t). The genre selected is given by the multi-armed bandit arm defined as

$$a ( t ) = {argmax}_{a ∈ A} {\sum }_{u ∈ G} {x}_{u} ( t ) ( {\overline{θ}}_{u , a} + \sqrt{\frac{2 ln {n}_{u}}{{n}_{u , a}}} )$$

Subsequently, the recommendation engine suggests a movie from that genre to the users in S(t); the users react by providing the recommendation engine with ratings, which are then used to update the estimates θ_{u,a} for the multi-armed bandit algorithm arm a=a(t) and for users u∈S(t). Intuitively, the above strategy for genre selection strikes a balance between displaying movies from genres that fit the interests of users as disclosed so far, while also favoring genres for which user interests are not well known yet (i.e., n_{u,a} is low). This allows new genres to be initially suggested before the recommendation engine gathers information on past weight vectors from user and group reviews. Stated differently, the recommendation engine customizes the group recommendation to the members that are present by selecting a category with high expected ratings within present group members (through the estimates θ_{u,a}) while also selecting categories that these member have not rated much (through n_{u,a}).

Given a vector x∈X, an optimal genre a*(x) is a genre that maximizes the expected group rating, i.e.,

$${a}^{*} ( x ) = {argmax}_{a ∈ A} 〈 x , {θ}_{a} 〉$$

Given a policy {a(t)}ₜ₋₁^{T}, the regret characteristic of the recommender is defined after T sessions to be

R(T)=Σₜ₋₁^{T} [symbol] x(t), θₐ*₍ₓ₍ₜ₎₎ [symbol] −Σₜ₌₁^{T}<x(t), θₐ₍ₜ₎>,

where a*(x(t)) is a genre that is optimal at time t. In other words, as in the classic prior art multi-armed bandit problem, the regret is the difference between expected rewards of an optimal policy and the policy {a(t)}ₜ₌₁^{T}. However, in contrast to the classic setup the optimal arm in the present invention may change with each session, as it depends on the weight vector x(t). As before, if the policy is random, the regret is defined as the expectation of over all sample paths of {a(t)}ₜ₌₁^{T}.

However, the inventors have determined that the regret characteristic of the present invention, where individual user ratings of a subset of a group are considered, is logarithmic instead of linear. Specifically, the regret characteristic of the current invention can be bounded according to the following:
Given x∈χ, denote by Bₓ⊂A the set of suboptimal genres under x, i.e., Bₓ={a∈A: <x,θₐ*₍ₓ₎><<x,θₐ>} Moreover, let

Δ^{a}ₘᵢₙ=inf_{x∈χ:a∈Bx}<x,θₐ*_{(x)>-<x,θ}ₐ>.

### Then,

$$R ( T ) \leq {\sum }_{a ∈ A} \frac{8 {M}_{1}^{3} d}{( {Δ}_{min}^{a} ) ( {Δ}_{min}^{a} )} ln T + 4 {KdM}_{1}$$

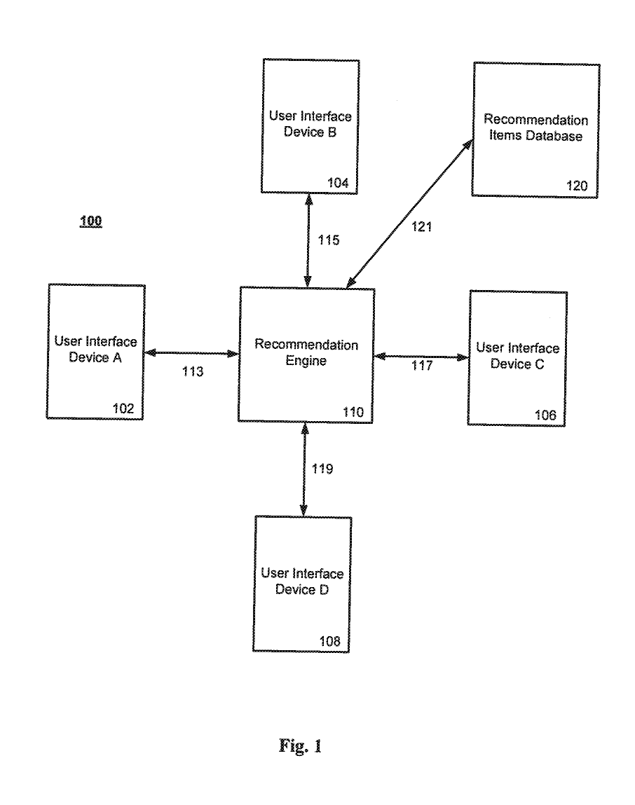

The above bound establishes that the inventive method achieves logarithmic regret compared to an optimal policy that has full view of user preferences. It also holds for arbitrary sequences x(t)∈χ: irrespectively of which subsets of users show up, and how the ratings of these users are weighted, the regret will be logarithmic and the bound applies. Crucially, it does not depend on the number of groups, which can be exponential in the group size. Hence, the method has very good performance, indeed providing suggestions that meet the preferences of users, while also discovering what theses interests are. FIG. 1 illustrates one embodiment 100 of the invention where a recommendation engine, using the modified multi-armed bandit (MMAB) algorithms described herein, can provide recommendations to one or more groups using multiple user devices. In FIG. 1, User Interface Devices A though D (102, 104, 106, and 108 respectively) can communicate with the recommendation engine 110. Although only four user interface devices are shown, the system 100 may accommodate many more user interface devices (not shown). The recommendation engine 110 provides recommendations to a group of individuals, not just one individual, by using the MMAB algorithms and initial user inputs and user feedback. Data on the users and groups may be stored in separate caches (not shown) within or remotely to the recommendation engine such that the engine 110 can support changing and/or mobile groups. User interface devices A-D can be any form of user device. For example, the user interface devices may be smart phones, personal digital assistants, display devices, laptop computers, tablet computers, computer terminals, or any other wired or wireless devices that can provide a user interface. Recommendation Items database 120 contains one or more databases that can be used as a data source for recommendations items. For example, if a group wishes to receive a movie recommendation, then items database 120 would contain at least many movie titles and characteristics. If a group wishes to receive an activity recommendation, then the items database would contain at least many activity items. If a group wishes to receive a book recommendation, then items database would contain at least many book titles.

In one embodiment, the system 100 of FIG. 1 is useful for one group or a subgroup of a larger group. In this instance, user interface device A, B, and C could be wireless devices, such as cell phones, laptops, PDAs, remote controls, or any combination of wireless or wired devices that allow the users of group A to request and receive a recommendation for an item such as a movie, an activity, a book, or other information or digital content. User Interface Device D may be a display device that allows the users of the group to view a list of recommended items, or display the selected item. As an aspect of the invention, user feedback on recommendations provided by the engine 110 is desirable. Thus, User interface devices A-D may be used for that purpose.

In another embodiment the system 100 of FIG. 1 may be used as a basic architecture to serve multiple groups or subgroups. User interface Device A can be a remote control device that accepts user inputs identifying one or multiple users of a group A. User interface device B can be a remote interface device that can be used by one or more individuals in a group B. User interface device C can be a display mechanism for the group A participants and User interface device D can be a display for the group B participants. Thus, recommendation engine 110 can provide recommendations of items from items database 120 to two separate groups, A and B, based on the makeup of the group. In principle, the basic architecture of FIG. 1 is expandable to support one or more groups of individuals with different request needs.

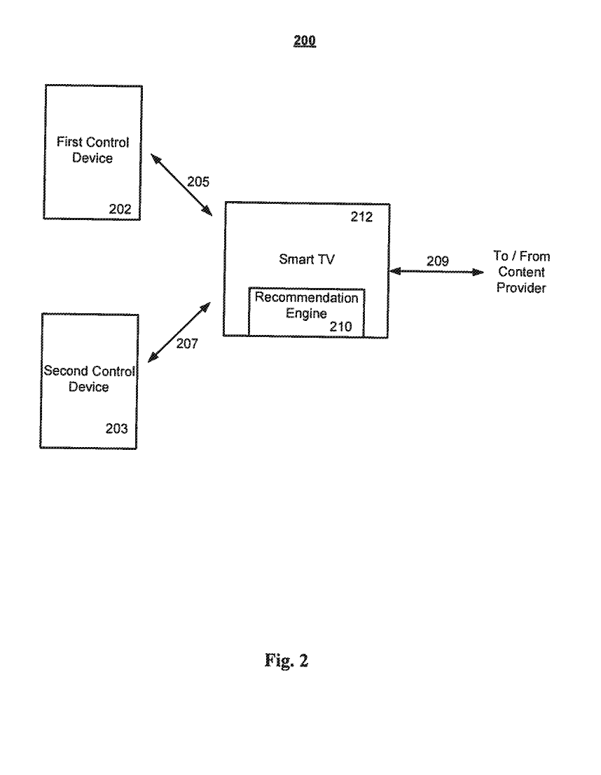

FIG. 2 is a system 200 illustrating the recommendation system concept of the present invention embodied in a smart TV 212. Alternately, the recommendation engine can form a part of a modem, or set top box, or router. In FIG. 2, the smart TV implementation is shown. Here, a smart TV 212 having a recommendation engine 210 is shown connected to a content provider via link 209. The communications connection 209 may be either a wired or a wireless connection. The content provider provides the recommendation engine with a database of items, such as movies, video, music, products, services, activities, and the like, such that the items can be recommended to a group of individuals based on the MMAB algorithms. The recommendation items database can be provided directly from the content provider or can be accessed separately. In FIG. 2, a user or group of users can use the first control device 202, such as a remote control connected to smart TV 212 via link 205, to identify the group, as a unit or via its individuals. The second control device 203 may be, for example, a tablet PC, a laptop computer, or a PDA connected to smart TV 212 via link 207. Links 205 and 207 may be either wired or wireless communications connections. The second control device 203 can be used in conjunction with the first control device 202 to help interface the group with the smart TV. For example, while the group is watching the smart TV 212 to receive a recommendation, second control device 203 may provide options to view on the smart TV 212 the suggested content including trailers, descriptions, parameter choices, and the like to allow group input on the recommendation. After viewing a selected recommendation, the users can use either the first control device 202 or the second control device 203 to provide feedback concerning the selected recommendation viewed on the smart TV 212 so that the MMAB algorithm may be updated to improve future recommendations for the group.

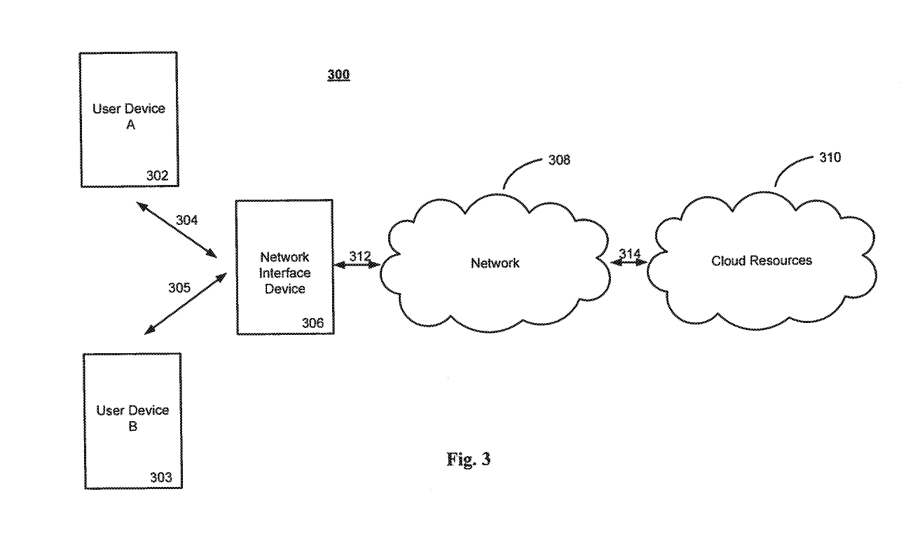

FIG. 3 depicts an embodiment of the invention which utilizes cloud resources to implement an equivalent of the recommendation engine of FIGS. 1 and 2. In the FIG. 3 system 300, a user device 302 or 303, such as a remote control, cell phone, PDA, laptop computer, tablet computer, or the like, may be used to access the network 308 via the network interface device 306. Communications links 304, 305, 312, and 314 connecting the various functional elements of FIG. 2 may be either wired or wireless connections. The network interface device 306 may be a wireless router, modem, network interface adapter, or other interface allowing user devices 302 and 303 to access a network 308. The network 308 may be any private or public network. Examples of network 308 can be a cellular network, an Intranet, an Internet, a WiFi network, a cable network of a content provider, or any other wired or wireless network including the appropriate interfaces for communication with the network interface device 306 and the cloud resources 310. The cloud resources 310 allow the user devices 302, 305 to access, via the network 308, resources such as servers that can provide the functionality required of a recommendation engine via the concept of cloud computing. The cloud resources 310 may also provide the recommendation items database (not shown) that a content provider would supply to support the recommendations that the recommendation engine contained in the cloud resources would require for operation. In another variation, the recommendation item database could be part of the network 308, which may be the network that a content provider supports.

Cloud computing is the delivery of computing as a service rather than a product, whereby shared resources, software, and information are provided to computers and other devices as a utility over a network (typically, but not limited to the Internet). Cloud computing provides computation, software applications, data access, data management and storage resources without requiring cloud users to know the location and other details of the computing infrastructure. End users can access cloud based applications through a web browser or a light-weight desktop or mobile application on their user devices while the business software and data are stored on servers at a remote location available via the cloud's resources. Cloud application providers strive to give the same or better service and performance as if the software programs were installed locally on end-user computers.

In another variation of FIG. 3, the network 308 and the cloud resources can be merged such that the combined network 308 and cloud resources 310 essentially provides all of the resources, including servers that provide the recommendation engine functionality and the recommendation item database storage and access.

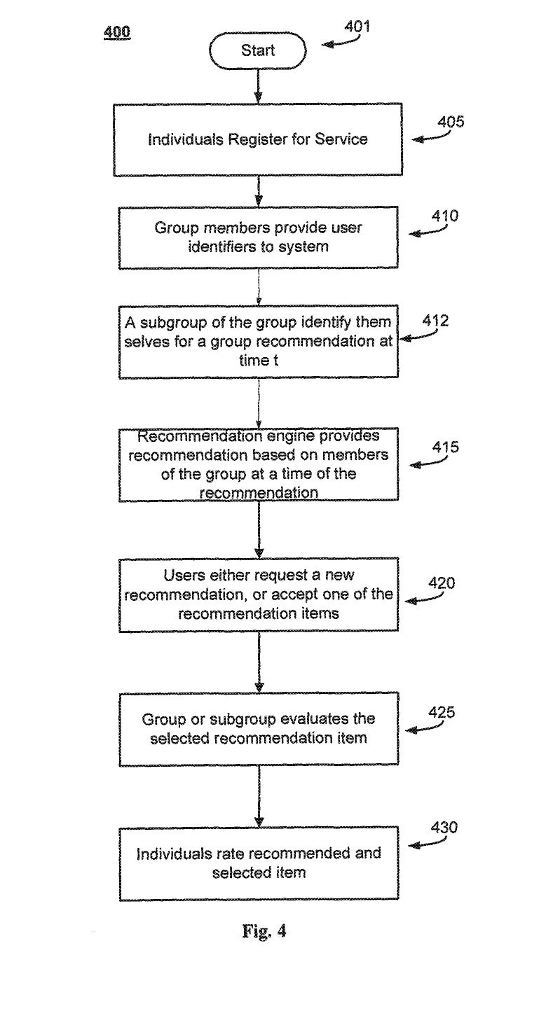

FIG. 4 depicts a basic block diagram of an events flow according to one aspect of the invention. The process starts at step 401 for a system according to any of FIG. 1, 2, or 3. At step 405, the individual registers for use of the recommendation service. This may involve entering individual identification information into a user interface device or a server apparatus. At step 410, one or more of the users identify the members of the group that will receive the item recommendation based on the entire set of users in that identified group. Thus, at step 405, individuals are identified and at step 410, groups are identified that contain identified individuals. At this time, weights can be applied to each individual within the group to establish a weight vector for the group or subgroup present at time t. this weighting helps define the characteristics of the members present that make up a subgroup of the entire group of members in the group. As an alternative to separate steps 405 and 410, individuals may simply register for the recommendation service by identifying themselves as members of a group of users. Weights for the users can be assigned by the recommendation engine or by specific members tasked to assign weights to individual members.

At step 412, the members of the group that are to be considered at a group recommendation time t are identified. In one aspect of the invention, the recommendation engine can generate a recommendation item not only for the entire group, but also, for a subset of the group. For example, if all of the members of the group are not present at a time t, then only the subset of the entire group (subgroup) membership are considered when making the recommendation. In this manner, a subset of the group (e.g. only the members of the group that are present at the time of recommendation) can receive a subset group recommendation that is customized to them. In this manner, group members that are not to be considered at the time of group recommendation are excluded from the recommendation determination. This ability of the modified multi-armed bandit algorithm to customize a recommendation based on a subset of the entire group allows a customization of the group recommendation for the only the attending members of the group. At step 412, the identified subgroup requests from the recommendation engine one or more recommendation items.

At step 415, the recommendation engine provides an item recommendation according to the specific attendance of members of an identified group that contains those individual members. Initially, the recommendation engine selects a category from a set of possible categories related to a recommendation item for a group. For example, if the recommendation system is one that recommends movie titles, the category selected by the recommendation engine is a movie genre. If the recommendation system is one that recommends a restaurant, the category that is selected is a dining cuisine. After selecting a category (such as a movie genre or dining cuisine or music genre, for example), then one or more specific recommendation items are selected from the category. The one or more recommendation items are then suggested for group consumption that corresponds to the selected category. The number of recommendation items provided as a group recommendation item may vary from 0 to n. The recommendation items are the output of the recommendation engine. The recommendation algorithm used by the recommendation engine is a modified multi-armed bandit (MMAB) algorithm.

At step 420, it is assumed that the group or subgroup decides which recommendation item to select and accepts the recommendation, or a new recommendation set may be requested. At step 425, the group or subgroup evaluates the selected recommendation item. This may involve engaging in a group or subgroup activity to assess the selected recommendation item. For example, if the recommendation item is a movie title, the subgroup views the movie title. If the recommendation item is a restaurant from the dining cuisine category, then the subgroup would dine at the suggested restaurant. At step 430, the individuals of the subgroup rate the selected recommendation item. This step provides feedback to the recommendation engine such that the MMAB algorithm can improve future recommendations for the group or subgroup of members. It is assumed that the group includes two or more individuals. At this point, another recommendation may be made may be made for the group. The next group recommendation mat be made for the same subgroup or a different subgroup by entering at step 412.

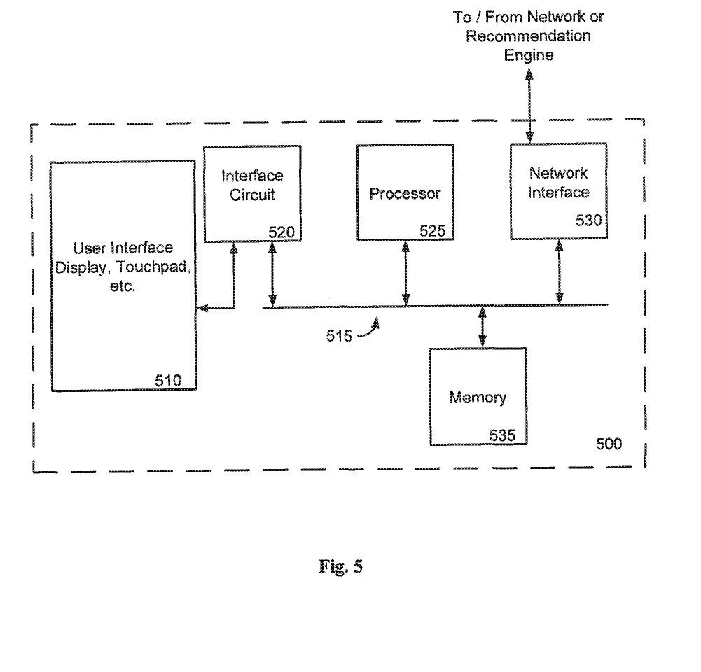

FIG. 5 depicts one type of user interface device 500 such as user interface device A 102 of FIG. 1. This type of user interface device can be a remote control, a laptop or table PC, a PDA, a cell phone, or a standard personal computer or the like. This device may typically contain a user interface portion 510, such as a display, touchpad, touch screen, menu buttons, or the like for a user to conduct the steps of individual and group user data entry as well as reception of recommendations for the group identified by the users. Device 500 may contain an interface circuit 520 to couple the user interface 510 with the internal circuitry of the device, such as an internal bus 515 as is known in the art. A processor 525 assists in controlling the various interfaces and resources for the device 500. Those resources include a local memory 535 used for program and/or data storage and well as a network interface 530. The network interface 530 is used to allow the device 500 to communicate with the network of interest. For example, the network interface 530 can be a wired or wireless interface for the functionality described for user interface device A 102 of FIG. 1 to communicate with the recommendation engine 110. Alternately, the network interface of 530 may be an interface as shown in FIG. 2 connecting the first or second control devices 202 or 203 to communicate with the smart TV. Such an interface may be acoustic, RF, infrared, or wired. Alternately, the network interface 530 may be to a an external network interface device such as a router or modem as described for User Devices 302 or 303 of FIG. 3.

Other alternative user device type or configuration can be well understood by those of skill in the art. For example, if the user device of FIG. 1 is a digital television, then the architecture of the user device would be that of a digital television or monitor which can display a recommendations list or which can render or display the recommendation items themselves to the users.

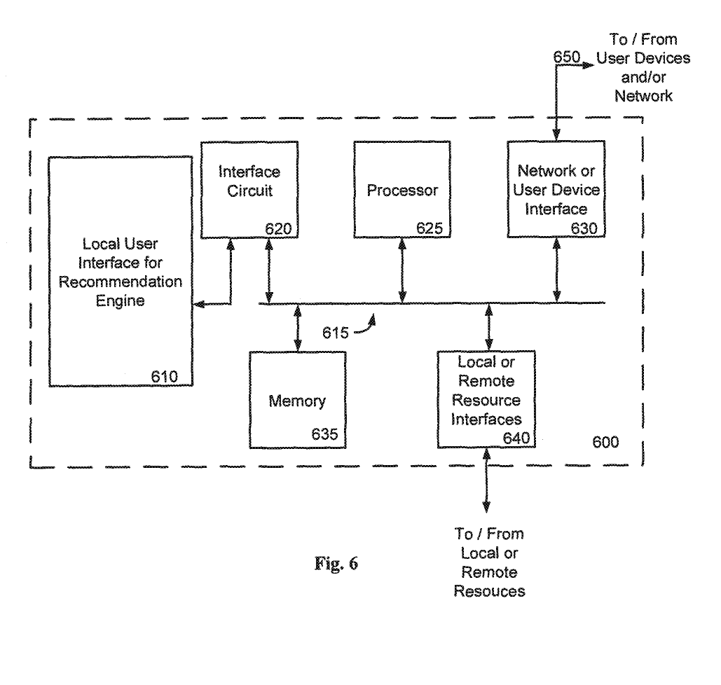

FIG. 6 is a depiction of an apparatus 600, such as a server or other electronic device, which can form the basis of a recommendation engine, such as that depicted in FIGS. 1 and 2. As expressed above, the recommendation engine may typically also be located in a device such as a smart TV, modem, router, or set top box or the like. Regardless of the form of the apparatus which contains the recommendation engine, the recommendation engine functionality may have a local user or administrator interface 610 which is coupled to an interface circuit 620 which may provide interconnection to an optional bus 615. Any such interconnection may include a processor 625, local memory 635, a network interface 630, and optional local or remote resource interconnection interfaces 640.

The processor 625 performs control functions for the recommendation engine or server apparatus as well as providing the computation resources for determination of the recommendation list provided to the users of the recommendation engine. The processor 625 acts to execute a program, in software, firmware, or hardware, using the MMAB to determine one or more recommendation items to a group or subgroup of users. For example, the MMAB algorithm may be processed by processor 625 using local program and data resources memory 635. Note that the processor 625 may be a single processor or multiple processors, either local to server 600 or distributed via interfaces 630 and/or 640. Processing of the MMAB algorithm and a flow diagram such as that of FIG. 4 requires access to the user data inputs acquired via a user interface device, such as that in FIG. 5, and use of a recommendations items database such as that shown in FIG. 1 or described in text describing FIGS. 2 and 3. Network or user device interface 630 may be used for primary communication in a network, such as a connection to an Internet, cell phone, or other private or public external network to allow access to the apparatus 600 by the supporting external network. For example, network interface 630 may be used for primary communication between the user devices, as in FIG. 5, and the recommendation engine to receive requests and feedback from users and to provide recommendations to groups of users. Network or user device interface 630 may also be used to collect information regarding potential items for recommendations stored in a database if such a database is located on a supporting external network at connection 650. In one embodiment, connection 650 may be either network 308 and 309 of FIG. 3. Alternately, connection 650 could be one of many direct connections to a user device as in the configuration of FIG. 1. In another configuration, if resources such as parallel computing engines, memory, or a database of recommendation items is located either on a different network than that of interface connection 630 or an a local network, then interface 640 may be used to communicate with that local or remote network. In one embodiment, interface 640 provides an alternative to or a supplement for interface connection 630. In one example, interface 640 can have local database access that supplements any database access accessible via connection 650 via interface 630. It is to be noted that apparatus 600 may be located on an identifiable network as a distinct entity or may be distributed to accommodate cloud computing as described for FIGS. 2 and 3.

Although specific architectures are shown for the implementation of a user device in FIG. 5 and a server type apparatus in FIG. 6, one of skill in the art will recognize that implementation options exist such as distributed functionality of components, consolidation of components, and use of internal busses or not. Such options are equivalent to the functionality and structure of the depicted and described arrangements.

1. A method performed by an apparatus for generating a recommendation item for members of a group of users, the method comprising:
registering members of the group of users;
identifying a subgroup of the group of users, the subgroup requesting a recommendation item from the apparatus;
determining a recommendation item for the subgroup, the recommendation item determined using a multi-armed bandit algorithm having a logarithmic regret characteristic utilized in a processor of the apparatus; and
providing the recommendation item to the subgroup of members of the group.

2. The method of claim 1, wherein determining the recommendation item further comprises using a weight vector at time t, wherein the weight vector represents weights of individual subgroup members at time t.

3. The method of claim 2, wherein determining the recommendation item further comprises using past weight vectors, past genres, and past ratings received by the individual subgroup members.

4. The method of claim 1, wherein determining the recommendation item comprises selecting a category from a set of categories, and selecting a recommendation item within the selected category.

5. The method of claim 4, further wherein the category is a movie genre or a dining cuisine.

6. The method of claim 1, further comprising the steps of:
accepting or rejecting the recommendation item by the subgroup; and
evaluating and rating the selected recommendation item.

7. The method of claim 6, wherein rating the selected item comprises providing a rating of the selected recommendation item by members of the subgroup individually.

8. An apparatus for providing a recommendation item to a group of users, the apparatus comprising:
an interface for communicating with one or more user devices;
a processor that executes a program to determine a recommendation item to suggest to a subgroup of the group of users;
memory, available to the processor for storing the program, wherein when executed by the processor, the program utilizes a multi-armed bandit algorithm having a logarithmic regret characteristic to determine the recommendation item.

9. The apparatus of claim 8, wherein the processor determines the recommendation item by first selecting a category from a set of categories, and then selecting a recommendation item within the selected category.

10. The apparatus of claim 8, wherein the processor determines the recommendation item using a weight vector at time t, wherein the weight vector represents weights of individual subgroup members at time t.

11. The apparatus of claim 8, wherein the interface for communicating with one or more user devices comprises a network interface attached to the one or more user devices, the interface useful to deliver the recommendation item to users of the apparatus.

12. The apparatus of claim 11, wherein the interface for communicating with one or more user devices functions to transfer, from the one or more user devices to the apparatus, rating information concerning the recommendation item.

13. The apparatus of claim 12, wherein the processor collects and processes the rating information from each member of the subgroup separately using the multi-armed bandit algorithm, applying different weights assigned to each member of the subgroup.

14. The apparatus of claim 8, wherein the apparatus comprises one of a television, a modem, a router, or a set top box.
